(19) United States
(12) Patent Application Publication
(10) Pub. No.: US 2007/0213215 A1
(43) Pub. Date: Sep. 13, 2007

(54) Multi-color dual-sided thermal printing

(75) Inventors: David Dashiell, Miamisburg, OH (US); Simon McCouaig, Centerville, OH (US); Marcia Dressler, Centerville, OH (US); Timothy Baker, Miamisburg, OH (US); Gerard Mullen, Miamisburg, OH (US)

Correspondence Address: CHARLES MANEY;NCR CORPORATION, LAW DEPT., 1700 S. PATTERSON BLVD., DAYTON, OH, 45479-0001, US

(73) Assignee: NCR Corporation

(21) Appl. No.: 11/633,300

(22) Filed: Dec. 4, 2006

Related U.S. Application Data
(60) Provisional application No. 60/779,781, filed on Mar. 7, 2006.
(60) Provisional application No. 60/779,782, filed on Mar. 7, 2006.

(51) Int. Cl. B41M 5/40

(52) U.S. Cl. 503/226

(57) ABSTRACT

There is provided a dual-sided thermal medium which comprises a thermally-resistant substrate including a first side and a second side, a first coating on the first side of the substrate including at least one thermal color imaging component, and a second coating on the second side of the substrate including at least two thermal color imaging components, wherein the thermal resistance of the substrate is sufficient to prevent heat applied to one of the first coating and the second coating from imaging at least one thermal color imaging component of the other of the first coating and the second coating. Also provided are a dual-sided direct thermal printer, dual-sided thermal printing system, and method to image the dual-sided thermal medium.

### CROSS REFERENCE TO RELATED APPLICATIONS

This application claims priority to U.S. Provisional Application No. 60/779,781 entitled “Two-Sided Thermal Printing” and filed on Mar. 7, 2006, and U.S. Provisional Application No. 60/779,782 entitled “Dual-Sided Thermal Printer” and filed on Mar. 7, 2006; the disclosures of which are hereby incorporated by reference herein.

### TECHNICAL FIELD

This disclosure relates to direct thermal printing technology. More particularly, the disclosure is directed to multi-color imaging of direct dual-sided thermal media.

### BACKGROUND

In many industries and applications there has been a shift away from printing documents using bond paper, including transaction documents (e.g., receipts, tickets, gift certificates, sweepstakes and the like), toward printing documents using direct thermal paper (thermal media).

Direct thermal printing has undergone significant development and has been adapted for use in many different industries and applications. Generally with direct thermal printing, information is provided or printed on just one side of the document. However, the development of dual-sided direct thermal printing permitted dual-sided printing of documents, such as transaction documents. Examples of dual-sided direct thermal printing are described in U.S. Pat. Nos. 6,784,906 and 6,759,366.

In dual-sided direct thermal printing, the printer is configured to allow concurrent printing on both sides of a thermal media moving along a feed path through the thermal printer. In such a printer, a direct thermal print head is disposed on each side of the thermal media along the feed path. In operation, each thermal print head faces an opposing platen across the thermal media from the respective print head. During printing, the opposing thermal print heads selectively apply heat to the opposing sides of the thermal media, which include a substrate with a thermally sensitive coating on each of the opposing surfaces of the substrate, such that when heat is applied printing is provided on the thermal media.

### SUMMARY

In accordance with an embodiment, there is provided a dual-sided thermal medium, the thermal medium comprising: a thermally-resistant substrate including a first side and a second side; a first coating on the first side of the substrate including at least one thermal color imaging component; and a second coating on the second side of the substrate including at least two thermal color imaging components, wherein the thermal resistance of the substrate is sufficient to prevent heat applied to one of the first coating and the second coating from imaging at least one thermal color imaging component of the other of the first coating and the second coating.

In accordance with another embodiment, there is provided a dual-sided thermal medium, the thermal medium comprising: an opaque and thermally-resistant substrate including a first side and a second side; a first coating on the first side of the substrate including at least one thermal color imaging component; and a second coating on the second side of the substrate including at least two thermal color imaging components, wherein the thermal resistance of the substrate is sufficient to prevent heat applied to one of the first coating and the second coating from imaging at least one thermal color imaging component of the other of the first coating and the second coating.

In accordance with yet another embodiment, there is provided a dual-sided thermal medium, the thermal medium comprising: a substrate including a first side and a second side; and a first coating on the first side of the substrate including a mixture of a plurality of thermal color imaging components.

In accordance with a still another embodiment, there is provided a dual-sided direct thermal printer, the printer comprising: a first thermal print head positioned proximate to a first platen; a second thermal print head positioned proximate to a second platen, with the first thermal print head being in a substantially opposed relation to the second platen and the second thermal print head being in a substantially opposed relation to the first platen; and the first thermal print head and the second thermal print head being adapted to be activated at a predetermined temperature and for a predetermined duration to image a respective first side and a second side of a dual-sided thermal medium in color.

In accordance with a further embodiment, there is provided a method of imaging a dual-sided thermal medium including a first side and a second side opposite the first side, the method comprising: receiving imaging data having color information; and controlling activation of a first thermal print head and a second thermal print head to image the respective first side and second side of the dual-sided thermal medium with the received imaging data in color identified by the color information.

In accordance with still a further embodiment, there is provided a dual-sided thermal printing system, the system comprising a dual-sided thermal medium including: a thermally-resistant substrate including a first side and a second side; a first coating on the first side of the substrate including at least one thermal color imaging component; and a second coating on the second side of the substrate including at least two thermal color imaging components, wherein the thermal resistance of the substrate is sufficient to prevent heat applied to one of the first coating and the second coating from imaging at least one thermal color imaging component of the other of the first coating and the second coating; and a dual-sided direct thermal printer including: a first thermal print head positioned proximate to a first platen; a second thermal print head positioned proximate to a second platen, with the first thermal print head being in a substantially opposed relation to the second platen and the second thermal print head being in a substantially opposed relation to the first platen; and the first thermal print head and the second thermal print head being adapted to be activated at a predetermined temperature and for a predetermined duration to image the first coating and the second coating on a respective first side and second side of the dual-sided thermal medium in color.

In accordance with yet a further embodiment, there is provided a dual-sided thermal printing system, the system comprising a dual-sided thermal medium including: an opaque and thermally-resistant substrate having a first side and a second side; a first coating on the first side of the substrate having at least one thermal color imaging component; and a second coating on the second side of the substrate having at least two thermal color imaging components, wherein the thermal resistance of the substrate is sufficient to prevent heat applied to one of the first coating and the second coating from imaging at least one thermal color imaging component of the other of the first coating and the second coating; and a dual-sided direct thermal printer including: a first thermal print head positioned proximate to a first platen; a second thermal print head positioned proximate to a second platen, with the first thermal print head being in a substantially opposed relation to the second platen and the second thermal print head being in a substantially opposed relation to the first platen; and the first thermal print head and the second thermal print head being adapted to be activated at a predetermined temperature and for a predetermined duration to image the first coating and the second coating on a respective first side and second side of the dual-sided thermal medium in color.

In accordance with another embodiment, there is provided a dual-sided thermal printing system, the system comprising a dual-sided thermal medium including: a substrate including a first side and a second side; and a first coating on the first side of the substrate including a mixture of a plurality of thermal color imaging components; and a second coating on the second side of the substrate including at least one thermal color imaging component; and a dual-sided direct thermal printer including: a first thermal print head positioned proximate to a first platen; a second thermal print head positioned proximate to a second platen, with the first thermal print head being in a substantially opposed relation to the second platen and the second thermal print head being in a substantially opposed relation to the first platen; and the first thermal print head and the second thermal print head being adapted to be activated at a predetermined temperature and for a predetermined duration to image the first coating and the second coating on a respective first side and second side of the dual-sided thermal medium in color.

### BRIEF DESCRIPTION OF THE DRAWINGS

Various features and attendant advantages of the example embodiments will be more fully appreciated as the same becomes better understood when considered in conjunction with the accompanying drawings, in which like reference characters designate the same or similar parts throughout the several views, and wherein:

FIG. 1 illustrates a schematic of an example dual-sided imaging direct thermal printer for imaging multi-color dual-sided thermal print media to produce a multi-color document;

FIGS. 2A-2B illustrate schematics of example thermal print heads of the thermal printer, in accordance with FIG. 1;

FIGS. 3A-3C illustrate schematic example cross-sectional views of the multi-color thermal print media, in accordance with FIG. 1;

FIGS. 4A-4B illustrate schematic cross top views of an example first side and an example second side, respectively, of a portion of the multi-color dual-sided thermal print media, in accordance with FIG. 1;

FIGS. 5A-5C illustrate schematic example cross sectional views of the multi-color dual-sided thermal print media, in accordance with FIGS. 1 and 4A-4B; and

FIG. 6 illustrates a schematic of a partial centerline elevation view of an example dual-sided imaging direct thermal printer for imaging multi-color dual-sided thermal print media, in accordance with FIG. 1.

### DETAILED DESCRIPTION

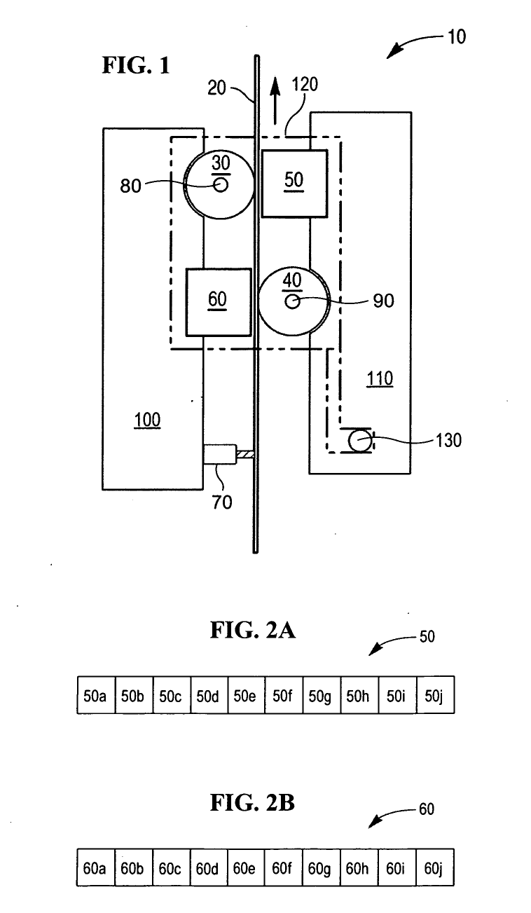

FIG. 1 illustrates a schematic of an example dual-sided imaging direct thermal printer 10 for imaging multi-color dual-sided thermal print media 20 to produce a multi-color document, such as a transaction document. It is to be noted that printer 10 may print a variety of other documents such as vouchers, coupons, receipts, tickets, gift certificates, sweepstakes and the like. Thermal printer 10 comprises support arms 100 and 110. Second support arm 110 may be journaled on an arm shaft 130 to permit arm 110 to pivot or rotate in relation to arm 100. The support arms 100 and 110 may also be in a fixed relation to one another. Thermal printer 10 further comprises platens 30 and 40 and opposing thermal print heads 50 and 60 on opposite sides of the thermal print media 20. More specifically, first support arm 100 comprises a first platen 30 and a first thermal print head 60, and the second support arm 110 comprises a second platen 40 and a second thermal print head 50.

Further with reference to FIG. 1, the platens 30 and 40 are substantially cylindrical in shape. The first platen 30 may be journaled on a first shaft 80 and the second platen 40 may be journaled on a second shaft 90. Each of shafts 80 and 90 are coupled to the support arms 100 and 110, respectively. Platens 30 and 40 are further rotatable via drive assembly 120 about shafts 80 and 90, respectively, for moving thermal print media 20 through the printer 10. The drive assembly 120 comprises a motor (not shown) for powering a system of gears, links, cams, and combinations thereof. The first and second thermal print heads 60 and 50 may be any thermal print heads suitable for direct multi-color thermal printing, such as those disclosed in U.S. Pat. Nos. 3,947,854; 4,708,500; and 5,964,541. Thermal printer 10 further comprises a sensor 70, such optical, electrical, mechanical, and like sensors for determining various conditions to control the operation of the thermal printer 10, such as a media sensor to detect a paper out condition.

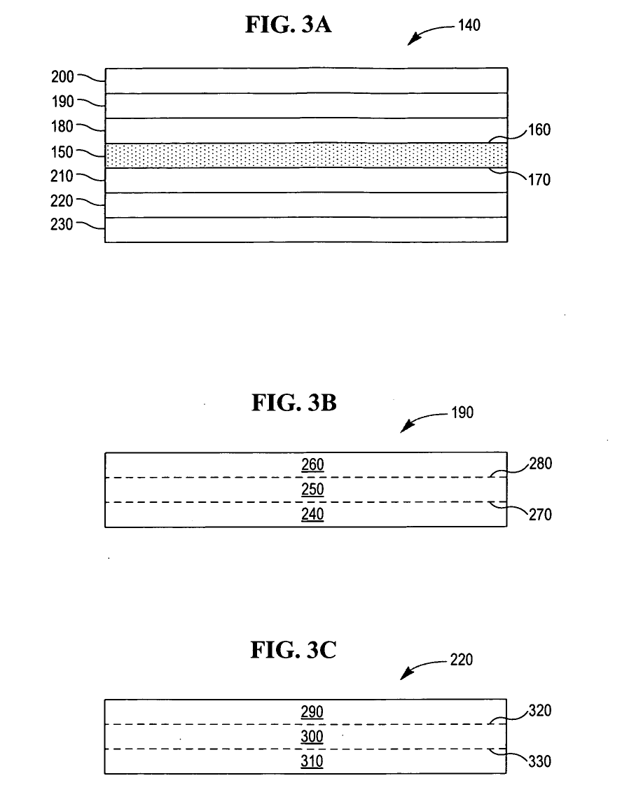

Still further with reference to FIG. 1, thermal printer 10 operates on thermal print media 20, which may be supplied in the form of a continuous paper roll, a continuous fan-folded stack, or pre-cut media (e.g., cards, tickets, receipts, tags, letter-sized sheets and the like), and upon which features such as multi-color graphics or text, and combinations thereof may be printed on one or both sides thereof, to provide a multi-color document, such as described hereinabove. The construction of the thermal multi-color print media 20 for printing multi-color documents will be described in greater detail with reference to FIGS. 3A-5C below.

Lastly with reference to FIG. 1, the multi-color dual-sided direct thermal printing of the multi-color print media 20 may be accomplished in a single pass process. Alternately, the multi-color dual-sided direct thermal printing may be accomplished in a process where the multi-color dual-sided media 20 may be imaged by one or both of the thermal print heads 50 and 60 when moving in a first direction, and then retracted for further imaging by the one or both thermal print heads 50 and 60 with the multi-color dual-sided media moving in either the first or the second, retract direction. Once printing is completed, the multi-color print media 20 may be ejected from the thermal printer 10 (if pre-cut media), or may be manually or automatically cut by the thermal printer, forming the printed document.

FIGS. 2A-2B illustrate schematics of example thermal print heads 50 and 60 of the thermal printer 10, in accordance with FIG. 1. More specifically, example thermal print head 50 includes imaging elements 50a-50j and example thermal print head 60 includes imaging elements 60a-60j. It is noted that the number of imaging elements depicted in each example thermal print head 50 and 60 is representative and this number may vary with particular print resolution requirements for the document to be imaged. Print resolution is typically measured in dots or pixels per inch (DPI) and each thermal print head 50, 60 may have a sufficient number of imaging elements for a resolution between about 100 DPI and about 600 DPI, although higher resolutions are also possible. For example, to image an eight-inch wide multi-color dual-sided print media 20 at 300 DPI may require each thermal print head 50, 60 to include about 2400 imaging elements.

Further with reference to FIGS. 2A-2B, each imaging element of thermal print heads 50, 60 may image a particular color at a pixel location in the multi-color dual-sided thermal print media 20 by producing a predetermined amount of heat for a predetermined duration of time to image a particular thermal imaging component of one or more thermal imaging components in the multi-color dual-sided thermal print media 20, as will be described in greater detail in FIGS. 3A-5C below. At this point it is sufficient to mention that the multi-color dual sided print media 20 may include a single color thermal imaging component or multiple color thermal imaging components on one or both sides of the media 20. A thermal imaging component may be a single color dye or dye precursor that may be imaged at a predetermined temperature and for a predetermined duration of time to produce a resulting color. Varying the duration of time may provide different color saturation levels. The predetermined temperature for the thermal imaging component may be from about 110° C. to about 210° C. depending on the thermal imaging component characteristics. Other temperature settings in combination with appropriately activated thermal imaging components may be used. The predetermined temperature may be achieved during the predetermined duration of time, which may be from about 1 microsecond to about 100 microseconds. More specifically, each imaging element of thermal print heads 50, 60 may produce the desired temperature in one or more pulses, with each pulse having a predetermined pulse width. For example, the pulse width may be about 1 microsecond. The interval of time between pulses may likewise be about 1 microsecond. To achieve a particularly desired saturation level for a particular thermal imaging component may require plural pulses.

Still further with reference to FIGS. 2A-2B, the thermal imaging components may also employ the CMY color model. More specifically, the thermal imaging components may include plural dyes or dye precursors (e.g., cyan, magenta and yellow), each of which may be imaged at a different temperature and a predetermined duration of time, to produce a resulting combined color. Each thermal imaging component may be imaged at a different temperature. For example, cyan may be imaged at 110° C., magenta may be imaged at 160° C. and yellow may be imaged at 210° C. Other temperature settings in combination with appropriately activated thermal imaging components may be used. Furthermore, the duration of time for imaging a respective thermal imaging component may vary from about 1 microsecond to about 100 microseconds, depending on the desired level of saturation for the respective thermal imaging component. Varying the saturation level of each respective thermal imaging component may facilitate the imaging of a multiplicity of resulting combined colors.

FIG. 3A illustrates a schematic example cross-sectional view 140 of the multi-color dual sided thermal print media 20, in accordance with FIG. 1. As depicted in FIG. 3A, multi-color thermal print media 20 may include a substrate 150 having a first surface 160 and a second surface 170, a first primer 180, a second primer 210, a first functional color coating 190, a second functional color coating 220, a first top coat 200 and a second top coat 230. The opacity of the substrate 150 may be generally opaque to inhibit color printing on one side of the print media 20 from penetrating or being visible on the other side of the print media 20 and causing color change of or a composite color with color printing on the other side. The first primer 180 may applied to the first surface 160 and the second primer 210 may be applied to the second surface 170 using any suitable process such as flooding and metering, followed by drying. Generally, flooding with an aqueous coating mixture and then metering off the excess accomplish the application of the primers 180, 210 to the substrate 150.

Further with reference to FIG. 3A, the first and second functional color coatings 190 and 220 may be applied, respectively, to the first and second primers 180 and 210 using any suitable process such as flooding and metering, followed by drying. Likewise, the first and second top coats 200 and 230 may be applied, respectively, to the first and second functional color coatings 190 and 220 using any suitable process such as flooding and metering, followed by drying. Alternatively, spraying, dipping or gravure coating may be used instead of flooding and metering, with respect to applying the first and second primers 180 and 210, the first and second functional color coatings 190 and 220, and/or the first and second top coats 200 and 230.

The first and second primers 180 and 210 and/or the first and second top coats 200 and 230 may be omitted, with the multi-color dual-sided thermal print media 20 including just the first and second functional coatings 190 and 220 applied directly to the respective first and second surfaces 160 and 170 of the substrate 150 using any suitable process as disclosed above.

Still further with reference to FIG. 3A, the multi-color dual-sided thermal print media 20 may include any one of the multiple categories of print media, some of which were described hereinabove. More specifically, the multi-color dual-sided media print media 20 may include any one of the following media categories: cards, tickets, receipts, tags, letter size (e.g., 8±2 inches×11 inches) and a variety of other sizes. In addition, each of the foregoing media categories may be provided as a continuous paper roll, a continuous paper stack, or may be precut. Further, each media category may have a specific size, thickness, substrate, opacity, protective layers or layers, and the like.

Cards may have a width of about 1½ inches to about 3 inches and a length of about 2 inches to about 4 inches; a thickness of about 8 mil to about 35 mil; a substrate of cellulosic or polymeric material; an opacity of generally opaque; and top coats that may impart resistance to water, ultraviolet light, and scratches or smears. The cards may be applied as room keys, cruise security cards, medical cards, credit cards, business cards, retail gift cards, cards with embedded radio frequency identification (RFID), corporate security cards, government security cards, trade show or conference security cards, small photo point of purchase photographs, library cards, parking permits, luggage tags, ID badges, and government high security cards. Other card applications are also possible.

Tickets may have a width of about 1 inch to about 4 inches and a length of about 2 inches to 8 inches; a thickness of about 8 mil to 25 mil; a substrate of cellulosic or polymeric material; an opacity of generally opaque; and top coats that may impart resistance to water, ultraviolet light, and scratches or smears. Tickets may be applied as boarding passes, parking passes, tickets (e.g., game tickets, amusement park tickets, movie tickets), as well as gaming and lottery tickets. Other ticket-like applications are also possible.

Receipts may have a width of about 2 inches to about 8 inches and a variable length as may be necessary to print the respective transaction and like information; a thickness of about 1½ mil to about 5 mil; a substrate that may be of cellulosic or polymeric material; an opacity that may be generally opaque; and top coats which are generally not necessary but which may include top coats mentioned hereinabove with respect to cards and tickets. Receipts may be applied as automatic teller machine (ATM) receipts/statements, point-of-sale receipts and kiosk information. Other receipt-type applications are also possible.

Tags may have a width of about ½ inch to about 2 inches and a length of about 1 inch to about 4 inches; a thickness of about 10 mil to about 35 mil; a substrate of celulosic or polymeric material; an opacity of generally opaque; and top coats which are generally not necessary but which may include top coats mentioned hereinabove with respect to cards and tickets. The tags may be applied to shelf-edge labeling, as radio frequency (RF) key fobs, price tags and clothing hang tags. Other tag-like applications are also possible.

Letter size paper may generally have a width of about 8½ inches and a length of about 11 inches (the width and the length may vary depending on the particular application); a thickness of about 3 mil to about 15 mil; a substrate of cellulosic or polymeric material; an opacity of generally opaque, although for some applications (e.g., decals) the opacity may be generally clear; and top coats which are generally not necessary but which may include top coats mentioned hereinabove with respect to cards and tickets. The letter size paper may be applied to direct mail coupons and advertisements, point of sale (POS) signage, labels, stationary, low volume roll-in-feed, pharmacy scripts, window decals, voting machine paper, plotter paper, business or home office correspondence, maps, facsimile paper, or medical graph paper. Other letter applications are also possible.

Larger paper sizes may generally have a width up to about 48 inches and a length up to about 10 feet (the width and the length may vary depending on the particular applications); a thickness of about 5 mil to about 25 mil; a substrate of cellulosic or polymeric material; an opacity of generally opaque; and top coats that may impart resistance to water, ultraviolet light, and scratches or smears. Large size paper may be applied as wide format signage and advertising. Other application are also possible.

Yet further with reference to FIG. 3A, the substrate 150 may include a cellulosic material. Suitable cellulosic materials include non-woven pulp-based materials. Alternatively, the substrate 150 may include a polymeric material, such as polypropylene or polyethylene, which may be in the form of a film. The first and second primers 180 and 210 may be of any suitable material to facilitate the adherence of the first and second functional coatings 190 and 220 to, respectively, the first and second surfaces 160 and 170 of the substrate 150. For example, the first and second primers 180 and 210 may be of a water-based mixture including mainly clay materials, which may be spread on the substrate 150 and then dried. The first and second primers 180 and 210 may be used to buffer the functional first and second coatings 190 and 220 from the active residue in the substrate 150.

Lastly with reference to FIG. 3A, one or more of the first and second functional color coatings 190 and 220 may include a single color thermal imaging component for imaging the thermal media 20 in a single color or multiple color thermal imaging components for imaging the thermal media 20 in multiple colors, as described above in reference to FIGS. 2A-2B. For example, at least three thermal imaging components (e.g., cyan, magenta and yellow) may be included to allow full multi-color imaging by thermal printer 10. In accordance with view 140 of FIG. 3A, the foregoing multiple thermal imaging components may be provided as a mixture, which when imaged thermal printer 10 changes from clear to colored in response to the appropriate application of heat to each constituent thermal imaging component, as particularly described above in reference to FIGS. 2A-2B. In addition, the multiple thermal imaging components may be mixed with appropriate binders, additives, solvents and reagents (e.g., activators) as desired to allow ease of coating when the functional coatings are applied as shown in FIG. 3A and the proper functioning of the multi-color dual-sided thermal print media 20 when imaged by thermal printer 10. Thus, when imaged, the multi-color dual-sided thermal print media 20 may include single color printing on both sides, single color printing on one side and full multi-color printing on the other side, or full multi-color printing on both sides. Further, the substrate 150 may have sufficient thermal resistance to inhibit heat applied to one side of the multi-color dual-sided thermal print media 20 in order to activate the functional coating 190 on that side, or one or more components thereof, from activating the functional coating 220 on the other side of the print media 20, or one or more components thereof.

FIGS. 3B-3C illustrate schematic example cross-sectional views of the functional coating 190 and 220 of the multi-color dual-sided thermal print media 20, in accordance with FIG. 1. Alternatively to the composition of the functional coatings 190 and 220 with a mixture of multiple thermal imaging components described with reference to FIG. 3A, one or more of the functional coatings 190 and 220 may be composed of plural thermal imaging component coats. More specifically, as shown in FIG. 3B, functional coating 190 may include a sandwich of thermal imaging component coats, such as thermal imaging component coats 240 (e.g., cyan), 250 (e.g., magenta) and 260 (e.g., yellow). The thermal imaging component coats 240, 250, 260 may further be separated by barrier coats 270, 280. More specifically, thermal imaging component coats 240 and 250 may be separated by a barrier coat 270 and thermal imaging component coats 250 and 260 may be separated by barrier coat 280. The barrier coats 270, 280 may have thermal characteristics to modify imaging and may have reagents to react with thermal imaging components to cause imaging. Further, the barrier coats 270, 280 may absorb heat to minimize imaging of deeper layers when upper layers are imaged, resulting in better print quality. Similarly, as shown in FIG. 3C, functional coating 220 may also include a sandwich of thermal imaging component coats, such as thermal imaging component coats 290 (e.g., cyan), 300 (e.g., magenta) and 310 (e.g., yellow). Thermal imaging component coats 290, 300, 310 may further be separated by barrier coats 320, 330. More specifically, thermal imaging component coats 290 and 300 may be separated by a barrier coat 320 and thermal imaging component coats 300 and 310 may be separated by barrier coat 330. It is noted that the composition of the functional layers 190 and 220 may be different from one another or may be the same based on particular requirements. More specifically, a functional coating 190, 220 may have a single imaging component, a mixture of thermal imaging components, or a sandwich of thermal imaging components.

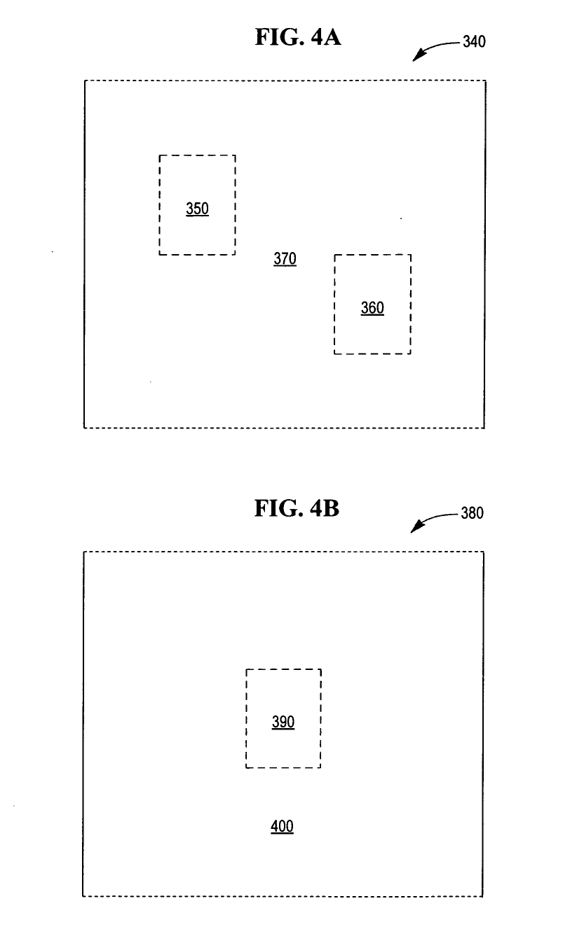

FIGS. 4A-4B illustrate schematic top views of an example first side 340 and an example second side 380, respectively, of a portion of the multi-color dual-sided thermal print media 20, in accordance with FIG. 1. More specifically, instead of applying single color or multi-color functional coatings to the entire area of the multi-color dual-sided thermal print media 20 as illustrated in FIGS. 3A-3C, the single color or multi-color functional coatings 190, 220 may be of a predetermined size and may be applied to predetermined area of the multi-color dual-sided thermal print media 20. Such predetermined color areas may include one or more spots, stripes, patterns, or regions of one or both sides of the dual-sided thermal print media 20, and may be contiguous with another, adjacent portion of the dual-sided thermal print media 20 for ease of coating application, printing and the like.

The color areas in multi-color dual-sided thermal print media 20 may be provided as follows. As illustrated in FIG. 4A, predetermined color areas 350 and 360 of first side 340 may each include a single color, while the remainder area 370 of the first side 340 may include another single color functional coating, such as black or another color. Alternatively, color areas 350 and 360 may each be multi-color (full color) functional coatings while the reminder area 370 is a single color functional coating, such as black or another color. Other colors or combinations of single or multi-color (full color) coatings are also possible.

Similarly, as illustrated in FIG. 4B, predetermined color area 390 of second side 380 may include a single color functional coating, while the remainder area 400 of the second side 380 may include another single color functional coating, such as black or another color. Alternatively, color area 390 may be a multi-color (full color) functional coating while the reminder area 400 may be a single color functional coating, such as black or another color, or an alternate full-color functional coating. As with the first side 340, other colors or combinations of single or multi-color (full color) coatings are also possible. Consequently, providing color areas 350, 360 and 390 in the functional coatings 190, 220 may save costs where color printing is desired just over a limited area.

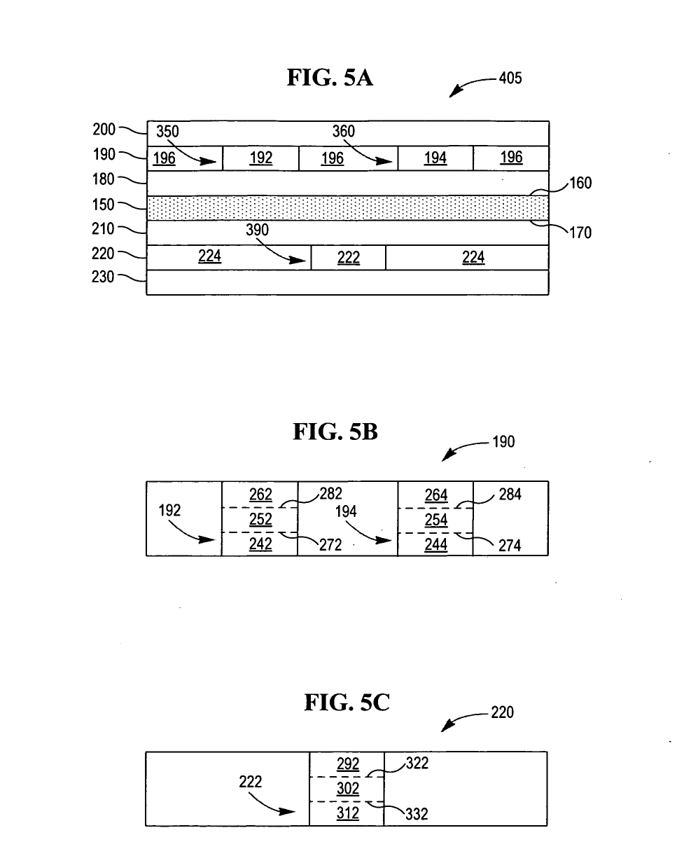

FIG. 5A illustrates a schematic example cross sectional view 405 of the multi-color dual-sided thermal print media 20, in accordance with FIGS. 1 and 4A-4B. As illustrated in and described in reference to FIG. 1, multi-color thermal print media 20 may include a substrate 150 having a first surface 160 and a second surface 170, a first primer 180, a second primer 210, a first functional color coating 190, a second functional coating 220, a first top coat 200 and a second top coat 230. As particularly illustrated in FIG. 5A, the first functional color coating 190 includes color portions 192 and 194 which make up the respective color areas 350 and 360 in FIG. 4A, and the second functional color coating 220 includes color portion 222 which makes up color area 390 in FIG. 4B. The first primer 180 may applied to the first surface 160 and the second primer 210 may be applied to the second surface 170 using any suitable process such as flooding and metering, followed by drying. Generally, flooding with an aqueous coating mixture and then metering off the excess accomplish the application of the primers 180, 210 to the substrate 150.

Further with reference to FIG. 5A, one or more of the color portions 192, 194 and 222 may include a single color thermal imaging component for imaging the thermal media 20 in a single-color or multiple color thermal imaging components for imaging the thermal media 20 in multiple colors, as described above in reference to FIGS. 2A-2B and 3A-3C. For example at least three thermal imaging components (e.g., cyan, magenta and yellow) may be included to allow full multi-color imaging by thermal printer 10. As described above, the multiple thermal imaging components may be provided as a mixture, which when imaged changes from clear to colored in response to the appropriate application of heat to each constituent thermal imaging component. The remaining portions 196 and 224 in respective functional color coatings 190, 220 may include a single color thermal imaging component (e.g., black) different from portions 192, 194, and 222, as may be desired based on particular requirements. As described before, the foregoing thermal imaging components may be mixed with appropriate binders, additives, solvents and reagents as desired to allow ease of coating when the functional coatings are applied as shown in FIG. 5A and the proper functioning of the multi-color dual-sided thermal print media 20 when imaged by the thermal printer 10. Thus, when imaged, the multi-color dual-sided thermal print media 20 may include single color printing on both sides in color portions 192, 194 and 222, single color printing on one side in color portions 192, 194, and full multi-color printing on the other side 222, or full multi-color printing on both sides in color portions 192, 194 and 222, as may be desired based on particular requirements. The substrate 150 may have sufficient thermal resistance to inhibit the heat applied to one side of the multi-color dual-sided thermal print media 20 in order to activate one functional color coating 190 on a first side of the media 20 (including a single color thermal imaging component or multiple color thermal imaging components) from activating the other functional coating 220 on a second side of the media 20 (including a single color thermal imaging component or multiple color thermal imaging components).

Further with reference to FIG. 5A, the first and second functional coatings 190 and 220, which include respective color portions 192, 194 and 222, and remaining portions 196 and 224 may be applied, respectively, to the first and second primers 180 and 210 using any suitable process such as flexographic, lithographic or gravure coating. The first and second top coats 200 and 230 may be applied, respectively, to the first and second functional color coatings 190 and 220 using any suitable process such as flooding and metering, followed by drying. The first and second primers 180 and 210 and/or the top coats 200 and 230 may be omitted, with the multi-color dual-sided thermal print media 20 including just the first and second functional coatings 190 and 220 applied directly to the respective first and second surfaces 160 and 170 of the substrate 150. The functional coatings 190 and 220 may also be applied using any suitable process, such as flooding and metering, followed by drying. Alternatively, spraying, dipping or gravure coating may be used instead of flooding and metering, with respect to applying the primers 180 and 210, functional coatings 190 and 220, and top coats 200 and 230.

FIGS. 5B-5C illustrate schematic example cross-sectional views of the functional color coatings 190 and 220 of the multi-color dual-sided thermal print media 20, in accordance with FIG. 1 and FIG. 4A. Alternatively to the composition of the color portions 192, 194 and 222 of the respective functional color coatings 190 and 220 with a mixture of multiple thermal imaging components described with reference to FIG. 5A, one or more of the color portions 192, 194 and 222 may be composed of plural thermal imaging component coats. More specifically, color portion 192 of the functional coating 190 may include a sandwich of thermal imaging component coats 242 (e.g., cyan), 252 (e.g., magenta) and 262 (e.g., yellow). The thermal imaging component coats 242, 252, 262 may further be separated with barrier coats 272 and 282. More specifically, thermal imaging component coats 242 and 252 may be separated by a barrier coat 272 and thermal imaging coats 252 and 262 may be separated by barrier coat 282. Color portion 194 of the functional coating 190 may also include a sandwich of thermal imaging component coats 244 (e.g., cyan), 254 (e.g., magenta) and 264 (e.g., yellow). Similarly, thermal imaging component coats 244 and 254 may be separated by a barrier coat 274 and thermal imaging component coats 254 and 264 may be separated by barrier coat 284. Functional coatings 190 and 220 in accordance with FIGS. 5B-5C may be accomplished via flexographic, lithographic or gravure spot coating techniques. Similarly, functional coating 220 may also include a sandwich of thermal imaging coats 292 (e.g., cyan), 302 (e.g., magenta) and 312 (e.g., yellow), which may be separated by barrier coats 322, 332. More specifically, thermal imaging coat 292 and 302 may be separated by a barrier layer 322 and thermal imaging coat 302 and 312 may be separated by barrier coat 332. It is noted that the composition of the color portions 192, 194 and 222 of the respective functional coatings 190 and 220 may be different from one another or may be the same based on particular requirements. More specifically, color portions 192, 194 and 222 may have a single color imaging component, a mixture of thermal imaging components, or a sandwich of thermal imaging component coats.

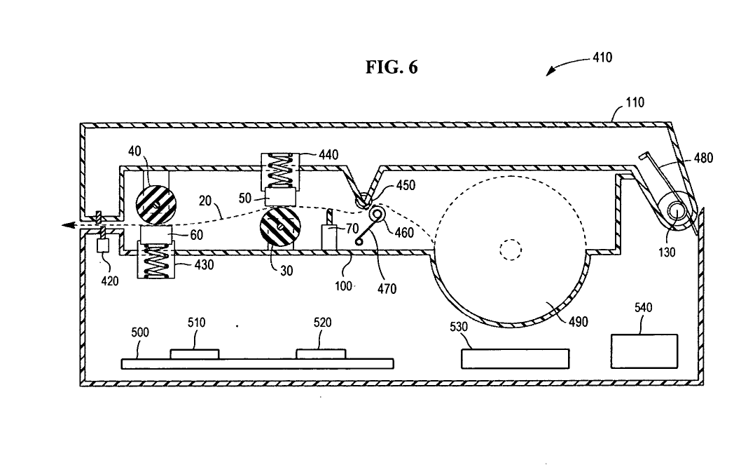

FIG. 6 illustrates a schematic of a partial centerline elevation view 410 of an example dual-sided imaging direct thermal printer 10 for imaging multi-color dual-sided thermal print media 20, in accordance with FIG. 1. Thermal printer 10 comprises first thermal print head 60, first platen 30, sensor 70 and first guide roller 460, all being coupled to a support arm 100 and all being on a first side of the thermal color print media 20. The feed path of thermal color print media 20 is shown by dashed lines of and an arrow at one end of the thermal print media 20. It is noted that thermal color print media 20 may be drawn from a continuous thermal print media roll 490 housed in the interior of the thermal printer between the first support arm 100 and the second support arm 110. The print media roll 490 may easily be substituted with a continuous fan-folded print media stack (not shown), similarly housed in the interior of the thermal printer 10. The media roll 490 or the fan-folded stack may also be provided on the outside (not shown) of the printer 10. It is further noted that continuous thermal print media roll or the fan-folded stack may be substituted with a tray (not shown) for storing one or more sizes of pre-cut thermal color print media 20. For precut thermal color print media 20, the printer 10 may provide means for retrieving the pre-cut thermal color print media 20 from the tray and moving it to be imaged. Alternatively or in addition, the printer 10 may also be provided with an external opening or slot (not shown) to accept the pre-cut thermal color print media 20.

Further with reference to FIG. 6, the thermal printer 10 also comprises a second thermal print head 50, second platen 40 and second guide roller 450, all being coupled to pivotable support arm 110 and all being on a second (reverse) side of the multi-color dual-sided thermal print media 20. The pivotable support arm 110 pivots about the arm shaft (or hinge) 130 to allow replacement of the thermal print media 20 and servicing of the thermal printer. When pivotable support arm 110 is closed in relation to support arm 100, the multi-color dual-sided thermal print media 20 may be engaged between first thermal print head 60 and opposed second platen 40, between second thermal print head 50 and opposed first platen 30, and between first guide roller 460 and opposed second guide roller 450. Contact pressure with and tension of the multi-color dual-sided thermal print media 20 may be maintained by spring loading first thermal print head 60, second thermal print head 50, and second guide roller 460 with spring mechanisms 430, 440 and 470, respectively. The thermal printer 10 also includes spring 480 that enables the pivotable arm 110 to open at a controlled rate in relation to arm 100, and thereby avoid, for example, uncontrolled closing of the arm 110 through force exerted on the arm 110 via the acceleration of gravity. The thermal printer 10 may also include an electronically activated mechanical cutting mechanism 420 to detach the multi-color dual-sided thermal print media 20 upon completion of a print operation, such as the printing of a receipt.

With further reference to FIG. 6, it is noted that the thermal print heads 50 and 60 are substantially in-line and face substantially opposed directions. As a result, the feed path of thermal print media 20 may be substantially a straight line path given the substantially in-line orientation of the thermal print heads 50 and 60. This configuration facilitates frontal exiting of the thermal print media 20 from the thermal printer. The in-line feed path also facilitates automation of thermal print media 20 replacement and feed, which includes allowing the thermal print media 20 to be automatically drawn from the second thermal print head 50 and first platen 30 through the first thermal print head 60 and second platen 40. Although the in-line orientation of thermal print heads 50 and 60 is described, alternate orientations of the first head 50 in respect to the second thermal print head 60, including varied angle orientations (e.g., 45, 90, 135 and 180 degrees), are possible based on particular design requirements of the thermal printer 10, the multi-color dual-sided thermal color print media 20 and/or desired media feed path.

Still with further reference to FIG. 6, the thermal printer 10 also comprises control electronics for controlling the operation of the thermal printer 10. The control electronics may include a motherboard 500, a microprocessor or central processing unit (CPU) 510, and memory 520, such as one or more dynamic random access memory (DRAM) and/or non-volatile random access memory (NVRAM) print buffer memory elements. The thermal printer 10 further comprises a communications controller 530 for communicating with one or more host or auxiliary systems, such as a point-of sale terminal (POS) (not shown) or a computer (not shown) for input of data to and output of data from the thermal printer 10. Communication controller 530 may support universal serial bus (USB), Ethernet and/or wireless communications, among others.

The data for printing, including the associated color information, may typically be supplied by a host POS terminal or a computer communicating with the thermal printer 10 via the communication controller 530. The CPU 510 may then process the received printing data (including associated color information) and may activate one or more elements 50a-50j, 60a-60j of the respective thermal print heads 50, 60 to image the printing data using the associated color information, as particularly described in reference to FIGS. 2A-2B above. More specifically, the CPU 510 may transform the associated color information to particular pulse temperature and durations when activating the one or more elements 50a-50j, 60a-60j of the respective thermal print heads 50, 60. The transformation may be achieved via a transform function, which may be stored in memory 520 and executed by the CPU 510. The transformation may further occur spatially to vary the number, temperature and duration of pulses applied to the various color spots, stripes, patterns, or regions of one or both sides of the dual-sided thermal print media 20 illustrated in FIGS. 3A-5C, wherein the particular characteristics including relative and/or absolute location of the various color spots, stripes, patterns, or regions of one or both sides of the dual-sided thermal print media 20 may be sensed by one or more print sensors 70 and the sensing signal transmitted to the CPU 510.

Lastly with reference to FIG. 6, memory 520 of the dual-sided direct thermal printer 10 may have a predefined print data storage area to store one or more blocks of predefined print data to be repetitively printed on one or both sides of the print media 20. The blocks of predefined print data may include, for example, a store identifier, a logo, and the like. In addition, the blocks of predefined data may further include legal information such as warranties, disclaimers, return policy, regulatory information, and the like. The predefined print data may be printed along with data submitted by application software associated with, for example, a POS terminal or computer on the same or the opposite media side of thermal print media 20. Where multiple data blocks are stored in the predefined print data storage area, the blocks may be alternatively selected for printing through use of a hardware or software switch 540, as may be the location or side of the media on which they are printed, and the like.

In operation of the thermal printer 10, and in accordance with FIGS. 1-6, the multi-color dual-sided thermal print media 20 may be unrolled from the continuous thermal print media roll 490, taken from a continuous fan-folded print media stack, or obtained from a paper tray or opening for pre-cut multi-color dual-sided thermal print media 20, and may be moved along the feed path through thermal print heads 50 and 60 for dual-sided imaging, after which it may be outputted to the outside of the thermal printer 10. In a print operation, CPU 510 receives via communication controller 530 printing data (including associated color information) and controls activation of imaging elements 50a-50j and 60a-60j of the respective one or more of the thermal print heads 50 and 60 for printing or imaging a variety of color graphics, text or combinations thereof on a respective side or location of the multi-color dual-sided thermal print media 20 in accordance with FIGS. 1-6.

In view of the foregoing, multi-color dual-sided thermal media and a multi-color dual-sided thermal printer therefor to image color documents have been described. The multi-color dual-sided thermal printer and multi-color dual-sided thermal media address dual-sided thermal color printing. The format and design of the multi-color dual-sided thermal media, including color areas or portions, provide for savings in imaging color documents.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the description. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

What is claimed is:

1. A dual-sided thermal medium, the thermal medium comprising:
a thermally-resistant substrate including a first side and a second side;
a first coating on the first side of the substrate including at least one thermal color imaging component; and
a second coating on the second side of the substrate including at least two thermal color imaging components, wherein the thermal resistance of the substrate is sufficient to prevent heat applied to one of the first coating and the second coating from imaging at least one thermal color imaging component of the other of the first coating and the second coating.

2. The thermal medium of claim 1, wherein opacity of the substrate is sufficiently opaque to prevent color imaged via the at least one thermal color imaging component on the first side from penetrating to the second side so as to cause change in color imaged via at least one thermal color imaging component on the second side.

3. The thermal medium of claim 1, further comprising:
a first primer disposed between the substrate and the first coating on the first side; and
a second primer disposed between substrate and the second coating on the second side.

4. The thermal medium of claim 1, wherein at least one thermal imaging component of one of the first coating and the second coating is a color dye or a dye precursor.

5. The thermal medium of claim 1, wherein at least one of the first coating and the second coating includes three thermal color imaging components.

6. The thermal medium of claim 5, wherein the three thermal color imaging components are cyan, magenta and yellow.

7. The thermal medium of claim 6, wherein at least one of the first coating and the second coating includes a mixture of the three thermal color imaging components.

8. The thermal medium of claim 5, wherein at least one of the first coating and the second coating includes:
a first thermal imaging component coat including a first thermal color imaging component;
a second thermal imaging component coat including a second thermal color imaging component; and
a third thermal imaging component coat including a third thermal color imaging component

9. The thermal medium of claim 8, further comprising:
a first barrier coat disposed between the first thermal imaging component coat and the second thermal imaging component coat; and
a second barrier coat disposed between second thermal imaging component coat and the third thermal imaging component coat.

10. The thermal medium of claim 5, wherein at least one of the first coating and the second coating includes at least one color portion that includes at least one thermal imaging component.

11. The thermal medium of claim 10, wherein one of the at least one color portion includes three thermal color imaging components.

12. The thermal medium of claim 11, wherein the three thermal color imaging components include cyan, magenta and yellow.

13. The thermal medium of claim 11, wherein one of the at least one color, portion includes a mixture of the three thermal color imaging components.

14. The thermal medium of claim 11, wherein the at least one color portion includes:
a first thermal imaging component coat including a first thermal color imaging component;
a second thermal imaging component coat including a second thermal color imaging component; and
a third thermal imaging component coat including a third thermal color imaging component.

15. The thermal medium of claim 1, further comprising a protective top coating over at least one of the first coating and the second coating.

16. A dual-sided thermal medium, the thermal medium comprising:
an opaque and thermally-resistant substrate including a first side and a second side;
a first coating on the first side of the substrate including at least one thermal color imaging component; and
a second coating on the second side of the substrate including at least two thermal color imaging components, wherein the thermal resistance is sufficient to prevent heat applied to one of the first coating and the second coating from imaging at least one thermal color imaging component of the other of the first coating and the second coating.

17. The thermal medium of claim 16, wherein opacity of the substrate is sufficiently opaque to prevent color imaged via the at least one thermal color imaging component on the first side from penetrating to the second side so as to cause change in color imaged via at least one thermal color imaging component on the second side.

18. The thermal medium of claim 16, further comprising:
a first primer disposed between the substrate and the first coating on the first side; and
a second disposed primer between substrate and the second coating on the second side.

19. The thermal medium of claim 16, wherein the at least one thermal imaging component of one of the first coating and the second coating is a color dye or a dye precursor.

20. The thermal medium of claim 16, wherein at least one of the first coating and the second coating includes three thermal color imaging components.

21. The thermal medium of claim 20, wherein the three thermal color imaging components are cyan, magenta and yellow.

22. The thermal medium of claim 21, wherein at least one of the first coating and the second coating includes a mixture of the three thermal color imaging components.

23. The thermal medium of claim 20, wherein at least one of the first coating and the second coating includes:
a first thermal imaging component coat including a first thermal color imaging component;
a second thermal imaging component coat including a second thermal color imaging component; and
a third thermal imaging component coat including a third thermal color imaging component.

24. The thermal medium of claim 23, further comprising:
a first barrier coat disposed between the first thermal imaging component coat and the second thermal imaging component coat; and
a second barrier coat disposed between second thermal imaging component coat and the third thermal imaging component coat.

25. The thermal medium of claim 20, wherein at least one of the first coating and the second coating includes at least one color portion that includes at least one thermal imaging component.

26. The thermal medium of claim 25, wherein one of the at least one color portion includes three thermal color imaging components.

27. The thermal medium of claim 26, wherein the three thermal color imaging components include cyan, magenta and yellow.

28. The thermal medium of claim 26, wherein one of the at least one color portion includes a mixture of the three thermal color imaging components.

29. The thermal medium of claim 26, wherein the at least one color portion includes:
a first thermal imaging component coat including a first thermal color imaging component;
a second thermal imaging component coat including a second thermal color imaging component; and
a third thermal imaging component coat including a third thermal color imaging component.

30. The thermal medium of claim 16, further comprising a protective top coating over at least one of the first coating and the second coating.

31. A dual-sided thermal medium, the thermal medium comprising:
a substrate including a first side and a second side; and
a first coating on the first side of the substrate including a mixture of a plurality of thermal color imaging components.

32. The thermal medium of claim 31, further comprising a second coating on the second side of the substrate including at least one thermal color imaging component.

33. The thermal medium of claim 32, wherein the second coating on the second side of the substrate includes:
a first thermal imaging component coat including a first thermal color imaging component;
a second thermal imaging component coat including a second thermal color imaging component; and
a third thermal imaging component coat including a third thermal color imaging component.

34. The thermal medium of claim 31, further comprising a second coating on the second side of the substrate including a mixture of a plurality of thermal color imaging components.

35. The thermal medium of claim 34, wherein the substrate is adapted to provide sufficient thermal resistance to prevent heat applied to one of the first coating and the second coating from imaging one or more thermal color imaging components of the other of the first coating and the second coating.

36. The thermal medium of claim 34, wherein opacity of the substrate is sufficiently opaque to prevent color imaged via one or more thermal color imaging components on the first side from penetrating to the second side so as to cause change in color imaged via one or more thermal color imaging components on the second side.

37. The thermal medium of claim 34, wherein at least one thermal imaging component in the mixture of the first coating or the second coating is a color dye or a dye precursor.

38. The thermal medium of claim 34, wherein the mixture of at least one of the first coating and the second coating includes three thermal color imaging components.

39. The thermal medium of claim 38, wherein the three thermal color imaging components are cyan, magenta and yellow.

40. The thermal medium of claim 34, wherein at least one of the first coating and the second coating includes at least one color portion that includes the mixture of the plurality of thermal color imaging components.

41. The thermal medium of claim 34, further comprising a protective top coating over at least one of the first coating and the second coating.

42. A dual-sided direct thermal printer, the printer comprising:
a first thermal print head positioned proximate to a first platen;
a second thermal print head positioned proximate to a second platen, with the first thermal print head being in a substantially opposed relation to the second platen and the second thermal print head being in a substantially opposed relation to the first platen; and
the first thermal print head and the second thermal print head being adapted to be activated at a predetermined temperature and for a predetermined duration to image a respective first side and a second side of a dual-sided thermal medium in color.

43. The printer of claim 42, further comprising a microprocessor adapted to:
receive imaging data having color information; and
activate one or more imaging elements of the first thermal print head and the second thermal print head to image the respective first side and the second side of the thermal medium with imaging data in color identified by the color information.

44. The printer of claim 43, wherein the microprocessor is further adapted to activate the one or more imaging elements in the first thermal print head and the second thermal print head in pulses at the predetermined temperature during the predetermined duration.

45. The printer of claim 43, wherein the microprocessor is further adapted to transform the received color information to the predetermined temperature and the predetermined duration to image the respective first side and a second side of the thermal medium in color identified by the color information.

46. The printer of claim 43, further comprising at least one sensor adapted to generate a sensing signal upon sensing a color portion of the first side or the second side of the thermal medium.

47. The printer of claim 46, wherein the microprocessor is further adapted to
receive the sensing signal from the sensor; and
transform the received color information to the predetermined temperature and the predetermined duration to image the sensed color portion in color identified by the color information.

48. A method of imaging a dual-sided thermal medium including a first side and a second side opposite the first side, the method comprising:
receiving imaging data having color information; and
controlling activation of a first thermal print head and a second thermal print head to image the respective first side and second side of the dual-sided thermal medium with the received imaging data in color identified by the color information.

49. The method of claim 48, wherein controlling activation further comprises:
activating one or more imaging elements in the first thermal print head and the second thermal print head at a predetermined temperature and for a predetermined duration of time associated with imaging the received imaging data in color identified by the color information.

50. The method of claim 49, wherein activating the one or more imaging elements further includes activating the one or more imaging elements in the first thermal print head and the second thermal print head in pulses at the predetermined temperature during the predetermined duration.

51. The method of claim 49, further comprising transforming the received color information to the predetermined temperature and the predetermined duration to image the respective first side and a second side of the thermal medium in color identified by the color information.

52. The method of claim 48, further comprising sensing a color portion of the first side or the second side of the thermal medium.

53. The method of claim 52, further comprising transforming the received color information to the predetermined temperature and the predetermined duration to image the sensed color portion in color identified by the color information.

54. A dual-sided thermal printing system, the system comprising:
a dual-sided thermal medium including:
a thermally-resistant substrate including a first side and a second side;
a first coating on the first side of the substrate including at least one thermal color imaging component; and
a second coating on the second side of the substrate including at least two thermal color imaging components, wherein the thermal resistance of the substrate is sufficient to prevent heat applied to one of the first coating and the second coating from imaging the at least one thermal color imaging component of the other of the first coating and the second coating; and
a dual-sided direct thermal printer including:
a first thermal print head positioned proximate to a first platen;
a second thermal print head positioned proximate to a second platen, with the first thermal print head being in a substantially opposed relation to the second platen and the second thermal print head being in a substantially opposed relation to the first platen; and
the first thermal print head and the second thermal print head being adapted to be activated at a predetermined temperature and for a predetermined duration to image the first coating and the second coating on a respective first side and second side of the dual-sided thermal medium in color.

55. A dual-sided thermal printing system, the system comprising:
a dual-sided thermal medium including:
an opaque and thermally-resistant substrate including a first side and a second side;
a first coating on the first side of the substrate including at least one thermal color imaging component; and
a second coating on the second side of the substrate including at least two thermal color imaging components, wherein the thermal resistance of the substrate is sufficient to prevent heat applied to one of the first coating and the second coating from imaging the at least one thermal color imaging component of the other of the first coating and the second coating; and
a dual-sided direct thermal printer including:
a first thermal print head positioned proximate to a first platen;
a second thermal print head positioned proximate to a second platen, with the first thermal print head being in a substantially opposed relation to the second platen and the second thermal print head being in a substantially opposed relation to the first platen; and
the first thermal print head and the second thermal print head being adapted to be activated at a predetermined temperature and for a predetermined duration to image the first coating and the second coating on the respective first side and second side of the dual-sided thermal medium in color.

56. A dual-sided thermal printing system, the system comprising:
a dual-sided thermal medium including:
a substrate including a first side and a second side; and
a first coating on the first side of the substrate including a mixture of a plurality of thermal color imaging components; and
a second coating on the second side of the substrate including at least one thermal color imaging component; and
a dual-sided direct thermal printer including:
a first thermal print head positioned proximate to a first platen;
a second thermal print head positioned proximate to a second platen, with the first thermal print head being in a substantially opposed relation to the second platen and the second thermal print head being in a substantially opposed relation to the first platen; and
the first thermal print head and the second thermal print head being adapted to be activated at a predetermined temperature and for a predetermined duration to image the first coating and the second coating on the respective first side and second side of the dual-sided thermal medium in color.
